(19) United States
(12) Patent Application Publication
(10) Pub. No.: US 2005/0260437 A1
(43) Pub. Date: Nov. 24, 2005

(54) Brazing composite material and brazed product using the same

(75) Inventors: Kazuma Kuroki, Hitachinaka (JP); Hiromitsu Kuroda, Hitachi (JP); Hideyuki Sagawa, Hitachi (JP); Sumio Shirai, Toyoda (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Cable, Ltd., Tokyo (JP)

(21) Appl. No.: 11/133,191

(22) Filed: May 20, 2005

(30) Foreign Application Priority Data
May 20, 2004 (JP) 2004-150585

(51) Int. Cl. B32B 15/00

(52) U.S. Cl. 428/655; 428/668

(57) ABSTRACT

A composite material for brazing has a brazing layer provided on a surface of a base metal. The brazing layer satisfies a requirement represented by formula: W1/W2=0.58 to 0.68 wherein W1 represents the weight of an Ni (nickel) ingredient contained in the brazing layer; and W2 represents the total weight of the Ni ingredient and a Ti (titanium) ingredient contained in the brazing layer.

The present application is based on Japanese patent application No. 2004-150585, the entire contents of which are incorporated herein by reference.

### BACKGROUND OF THE INVENTION

1. Field of the Invention

The invention relates to a brazing composite material, which comprises a base metal having a surface cladded with a brazing layer constituting a brazing material and has a self-brazing proper, and a brazed product using the same, and more particularly to a brazing composite material having improved bonding strength and corrosion resistance and a brazed product using the same.

2. Description of the Related Art

A brazing composite material comprises a base metal cladded with a brazing layer. When heat treatment is carried out in such a state that a material to be brazed is in contact with the brazing layer, the material can be brazed without the need to separately use any brazing material.

A brazing composite material known in the art comprises a base metal having a surface cladded with a brazing layer comprising Fe or an Fe alloy, Ti or a Ti alloy, and Ni or an Ni alloy stacked in that order from the base metal side (Japanese Patent Laid-Open No. 363707/2002).

Further, a stainless steel-base cladded brazing material comprising a stainless steel sheet as a base metal, one or both surfaces of which is cladded with copper as a brazing material, is known as a brazing composite material for use in the production of oil coolers for automobiles.

Various types of nickel brazing materials, which can provide a joint having excellent oxidation resistance and corrosion resistance, are specified in JIS (Japanese Industrial Standards) as brazing materials for components, for example, stainless steel-base, nickel-base, or cobalt-base alloys.

Further, a nickel brazing material comprising a powdery nickel brazing material and, added thereto, 4 to 22% by mass of powder of a metal selected from the group consisting of Ni (nickel), Cr (chromium), and an Ni—Cr alloy has been proposed as a nickel brazing material for joining of heat exchanger in Japanese Patent Laid-Open No. 107883/2000.

Furthermore, a production process of a self-brazing composite material is proposed which comprises stacking a second layer (a brazing layer) formed of nickel or a titanium-base material onto a first base layer (a base metal) formed of stainless steel or a nickel-base material (Japanese Patent Laid-Open No. 299592/1995).

Upon brazing of a material with the above brazing composite material, constituents of the base metal and/or the material to be brazed are diffused and penetrated into the melted brazing layer in the composite material. As a result, a mixture of the constituents of the brazing layer with the constituents of the base metal and/or the material to be brazed is solidified to constitute a brazing solidified part.

Therefore, the composition of the brazing solidified part is preferably one which improves the strength and the corrosion resistance. In the conventional brazing composite materials, however, it cannot be said that the composition of the brazing layer before brazing is designed by taking into consideration the diffusion and penetration of the constituents of the base metal and/or the material to be brazed so that the composition of the brazing solidified part after brazing has improved strength and corrosion resistance. For this reason, the conventional brazing composite materials do not have satisfactorily high bonding strength and corrosion resistance in the brazing solidified part after brazing and thus are not suitable for use, for example, in the production of members required to have bonding strength in the brazing solidified part and corrosion resistance, for example, heat exchangers (for example, coolers for exhaust gas recirculation devices, and coolers for fuel cell reformers) and fuel cells.

For example, in the above production process of a self-brazing composite material, when a brazing composite material comprising a first base layer (a base metal) formed of a stainless steel and a second layer (a brazing layer) formed of a material composed of 70% by mass of titanium and 30% by mass of nickel is produced and is used for brazing of an iron alloy, such as a stainless steel, as a material to be brazed by bringing the material into contact with the brazing layer in the composite material and then heat treating the assembly, it was found that Ni and Ti ingredients from the brazing layer as well as Fe and Cr ingredients from the stainless steel in the base metal and material to be brazed are diffused and penetrated into the brazing solidified part solidified after brazing and the contents of the Fe and Cr ingredients in the brazing solidified part each are not more than 15% by mass.

The brazing solidified part having the above composition is composed mainly of an Ni—Ti alloy which is very hard and brittle. Therefore, even the application of small external force is likely to cause cracking. Further, since a hard and brittle intermetallic compound is formed at the interface of the brazing solidified part and the stainless steel, the strength at the joint is very small. Therefore, the brazing solidified part (brazed part) was found to have very poor reliability in strength.

### SUMMARY OF THE INVENTION

It is an object of the invention to provide a brazing composite material which is improved in strength and corrosion resistance in the brazing solidified part after brazing by specifying the composition of the brazing layer before brazing.

(1) According to the first feature of the invention, a composite material for brazing comprises a brazing layer provided on a surface of a base metal, said brazing layer satisfying a requirement represented by formula:
W1/W2=0.58 to 0.68
wherein W1 represents the weight of an Ni (nickel) ingredient contained in the brazing layer; and W2 represents the total weight of the Ni ingredient and a Ti (titanium) ingredient contained in the brazing layer.

The brazing layer may comprise a Ni or Ni alloy layer, a Ti or Ti alloy layer, and an Fe (iron) or Fe alloy layer that are stacked in that order from the base metal side.

The brazing layer may have an Fe content of 10 to 40% by mass.

The base metal may be a stainless steel.

(2) According to the second feature of the invention, a brazed product comprises two materials brazed to each other with the aid of a brazing layer, said two materials being each the above composite material for brazing, or one of said two materials being the composite material for brazing with the other material being other steel product, a brazing solidified part formed after said brazing comprising 20 to 50% by mass of Fe, 15 to 25% by mass of Ti, 25 to 45% by mass of Ni, and 1 to 15% by mass of Cr.

The steel product may be a corrosion resistant steel product.

The brazing may be carried out in vacuum.

In the invention, since a specific weight ratio between the Ni ingredient and the Ti ingredient in the brazing layer before brazing has been adopted, the strength and corrosion resistance of the brazing solidified part after brazing are improved. In particular, when the composition of the brazing solidified part is one as defined in claim 6, the brazing solidified part is less likely to be cracked and has high bonding strength and, at the same time, can be highly corrosion resistant. Therefore, the brazing composite material is useful for use, for example, in the production of members for heat exchangers and fuel cells required to have strength and corrosion resistance.

### BRIEF DESCRIPTION OF THE DRAWINGS

The invention will be explained in more detail in conjunction with the appended drawings, in which:

FIG. 1 is a cross-sectional view of a brazing composite material in a preferred embodiment of the invention;

FIG. 2 is a cross-sectional view of an assembly after brazing between the composite material shown in FIG. 1 and other steel product; and

FIG. 3 is an explanatory view of a sample for a tensile test using the composite material shown in FIG. 1.

### DESCRIPTION OF THE PREFERRED EMBODIMENTS

Preferred embodiments of the invention will be explained in detail in conjunction with the accompanying drawings.

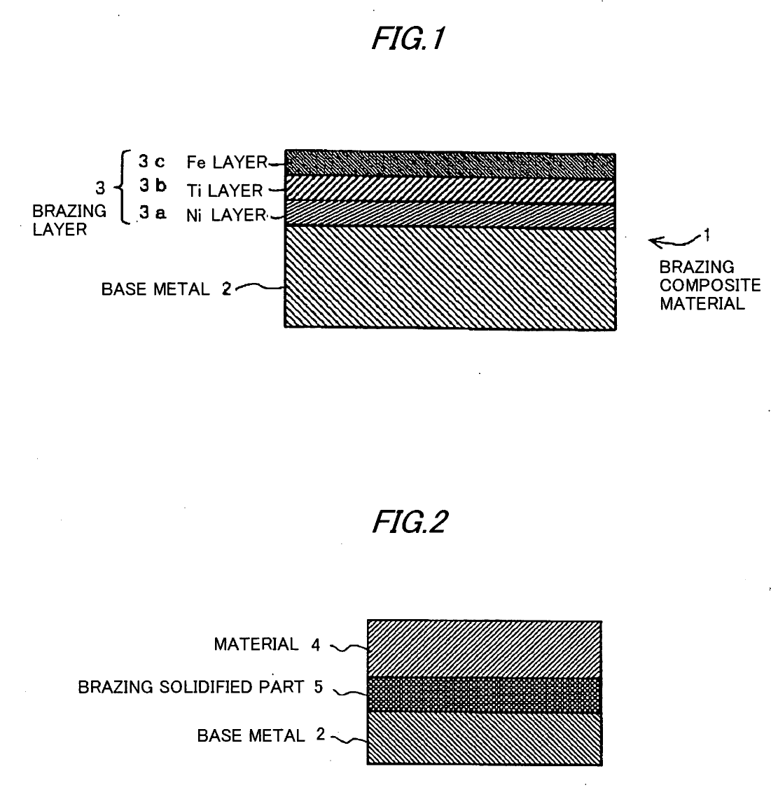

FIG. 1 is a typical cross-sectional view illustrating a brazing composite material 1 in conjunction with a preferred embodiment of the invention. The brazing composite material 1 includes a base metal 2 formed of a stainless steel. A surface of the base metal 2 is cladded with a brazing layer 3 constituting a brazing material. An nickel layer 3a formed of Ni or an Ni alloy, a Ti layer 3b formed of Ti or a Ti alloy, and an Fe layer 3c formed of Fe or an Fe alloy are stacked in that order from the base metal 2 side to constitute the brazing layer 3.

This preferred embodiment is characterized by adopting the following specific weight ratio between the Ni ingredient and the Ti ingredient contained in the brazing layer 3. Specifically, the brazing layer 3 satisfies a requirement represented by formula W1/W2=0.58 to 0.68 wherein W1 represents the weight of an Ni (nickel) ingredient contained in the brazing layer 3; and W2 represents the total weight of the Ni ingredient and a Ti (titanium) ingredient contained in the brazing layer 3. Further, the content of Fe in the brazing layer 3 is regulated to 10 to 40% by mass.

A material 4 to be brazed formed of a corrosion resistant steel product such as a stainless steel product (see FIG. 2) is brought into contact with the Fe layer 3c as the outermost layer in the brazing layer 3 of the brazing composite material 1, and, in this state, the assembly is heat treated for brazing. In the heat treatment, the brazing layer 3 is melted, and the material 4 is brazed to the base metal 2 through a brazing solidified part 5. Regarding conditions for the heat treatment for brazing, for example, the brazing temperature is 1150° C., the brazing time is 15 min, and the heat treatment is carried out in vacuum (degree of vacuum: 1.0×10⁻³ Pa).

FIG. 2 is a diagram showing a brazed part (after brazing) after the above heat treatment for brazing. As shown in the drawing, a brazing solidified part 5 is formed between the base metal 2 (stainless steel) in the brazing composite material 1 and the material 4 (stainless steel) to be brazed.

In the brazing solidified part 5, Fe and Cr ingredients from the base metal 2 (stainless steel) are diffused and penetrated into Ni, Ti, and Fe in the brazing layer 3 melted by the above heat treatment, and, as a result, the brazing solidified part comprises Fe: 20 to 50% by mass, Ti: 15 to 25% by mass, Ni: 25 to 45% by mass, and Cr: 1 to 15% by mass. This composition can be realized by specifying, for example, the ratio among the Ni ingredient, the Ti ingredient, and the Fe ingredient in the brazing layer 3 before brazing to the above value.

When the brazing solidified part 5 has the above composition, the brazing solidified part 5 is less likely to be cracked and, thus, high bonding strength can be provided and, at the same time, high corrosion resistance can be realized. Therefore, the brazing composite material 1 shown in FIG. 1 is suitable for use, for example, in the production of members required to have strength and corrosion resistance, for example, heat exchangers (for example, coolers for exhaust gas recirculation devices, and coolers for fuel cell reformers) and fuel cells.

The Fe layer 3c constituting the outermost layer in the brazing layer 3 functions to reduce the supply of the Fe ingredient from the stainless steel as the material 4 to be brazed to the brazing solidified part 5 during brazing and, thus, to suppress the reduction of the thickness of the material 4 to be brazed due to the reactive corrosion of the stainless steel.

When the content of the Fe ingredient in the brazing solidified part 5 is less than 20% by mass, the melting point of the brazing material is increased and, consequently, the flow of molten brazing material is inhibited. On the other hand, when the content of the Fe ingredient in the brazing solidified part 5 exceeds 50% by mass, satisfactory corrosion resistance cannot be provided. For the above reason, the content of the Fe ingredient in the brazing solidified part 5 is preferably 20 to 50% by mass, more preferably 25 to 50% by mass, still more preferably 25 to 45% by mass.

When the content of the Ti ingredient in the brazing solidified part 5 is less than 15% by mass, satisfactory corrosion resistance cannot be maintained. On the other hand, when the content of the Ti ingredient in the brazing solidified part 5 exceeds 25% by mass, the melting point of the whole brazing material is increased and, thus, the flow of the molten brazing material is hindered. For the above reason, the content of the Ti ingredient in the brazing solidified part 5 is preferably 15 to 25% by mass, more preferably 15 to 23% by mass, still more preferably 18 to 23% by mass.

When the content of the Ni ingredient in the brazing solidified part 5 is less than 25% by mass or more than 45% by mass, the melting point of the whole brazing material is increased and, thus, the flow of the molten brazing material is hindered. For the above reason, the content of the Ni ingredient in the brazing solidified part 5 is preferably 25 to 45% by mass, more preferably 27 to 45% by mass, still more preferably 27 to 42% by mass.

When the content of the Cr ingredient in the brazing solidified part 5 is less than 1% by mass, satisfactory corrosion resistance cannot be maintained. On the other hand, when the content of the Cr ingredient in the brazing solidified part 5 exceeds 15% by mass, uniform diffusion cannot be realized resulting in a variation in corrosion resistance. For the above reason, the content of the Cr ingredient in the brazing solidified part 5 is preferably 1 to 15% by mass, more preferably 5 to 12% by mass, still more preferably 7 to 12% by mass.

The degree of vacuum in the heat treatment for brazing is preferably not more than 1.0×10⁻² Pa (in this preferred embodiment, 1.0×10⁻³ Pa). When the degree of vacuum exceeds 1.0×10⁻² Pa, Ti diffused and distributed on the surface of the brazing material at a high temperature is reacted with very small amounts of oxygen, nitrogen and carbon in the atmosphere. As a result, a reaction product is formed on the surface of the brazing material and inhibits the melting of the brazing material.

### EXAMPLES

The brazing composite material according to the invention will be explained in more detail with reference to the following examples and comparative examples.

### Example 1

A brazing composite material (hereinafter referred to as “composite material”) of Example 1 is prepared as follows. At the outset, a coiled iron sheet with a thickness of 0.34 mm, a coiled pure titanium sheet with a thickness of 2.0 mm, and a coiled nickel sheet with a thickness of 1.67 mm are put on top of one another to form a three-layer structure. This structure is hot rolled to prepare a 0.3 mm-thick clad sheet. Subsequently, the clad sheet is cold rolled to prepare a 0.15 mm-thick clad sheet as a finished product.

A stainless steel strip (SUS 304, sheet thickness 1.5 mm) is cladded with this clad sheet by rolling, followed by cold rolling to prepare a 0.5 mm-thick composite material. In this composite material, the stainless steel strip part constitutes a base metal 2, and the clad sheet part constituted by the three layers constitutes a brazing layer 3 (the same shall apply hereinafter).

### Example 2

At the outset, a coiled iron sheet with a thickness of 0.76 mm, a coiled pure titanium sheet with a thickness of 2.0 mm, and a coiled nickel sheet with a thickness of 1.67 mm are put on top of one another to form a three-layer structure. This structure is hot rolled to prepare a 0.3 mm-thick clad sheet. Subsequently, the clad sheet is cold rolled to prepare a 0.15 mm-thick clad sheet as a finished product.

A stainless steel strip (SUS 304, sheet thickness 1.5 mm) is cladded with this clad sheet by rolling, followed by cold rolling to prepare a 0.5 mm-thick composite material.

### Comparative Example 1

At the outset, a coiled iron sheet with a thickness of 0.12 mm, a coiled pure titanium sheet with a thickness of 2.0 mm, and a coiled nickel sheet with a thickness of 1.02 mm are put on top of one another to form a three-layer structure. This structure is hot rolled to prepare a 0.3 mm-thick clad sheet. Subsequently, the clad sheet is cold rolled to prepare a 0.15 mm-thick clad sheet as a finished product.

A stainless steel strip (SUS 304, sheet thickness 1.5 mm) is cladded with this clad sheet by rolling, followed by cold rolling to prepare a 0.5 mm-thick composite material.

### Comparative Example 2

At the outset, a coiled iron sheet with a thickness of 0.26 mm, a coiled pure titanium sheet with a thickness of 2.0 mm, and a coiled nickel sheet with a thickness of 1.02 mm are put on top of one another to form a three-layer structure. This structure is hot rolled to prepare a 0.3 mm-thick clad sheet. Subsequently, the clad sheet is cold rolled to prepare a 0.15 mm-thick clad sheet as a finished product.

A stainless steel strip (SUS 304, sheet thickness 1.5 mm) is cladded with this clad sheet by rolling, followed by cold rolling to prepare a 0.5 mm-thick composite material.

### Comparative Example 3

At the outset, a coiled nickel sheet with a thickness of 0.51 mm, a coiled pure titanium sheet with a thickness of 2.0 mm, and a coiled nickel sheet with a thickness of 0.51 mm are put on top of one another to form a three-layer structure. This structure is hot rolled to prepare a 0.3 mm-thick clad sheet. Subsequently, the clad sheet is cold rolled to prepare a 0.15 mm-thick clad sheet as a finished product.

A stainless steel strip (SUS 304, sheet thickness 1.5 mm) is cladded with this clad sheet by rolling, followed by cold rolling to prepare a 0.5 mm-thick composite material.

### Comparative Example 4

At the outset, a coiled nickel sheet with a thickness of 0.45 mm, a coiled pure titanium sheet with a thickness of 2.0 mm, and a coiled nickel sheet with a thickness of 0.45 mm are put on top of one another to form a three-layer structure. This structure is hot rolled to prepare a 0.3 mm-thick clad sheet. Subsequently, the clad sheet is cold rolled to prepare a 0.15 mm-thick clad sheet as a finished product.

A stainless steel strip (SUS 304, sheet thickness 1.5 mm) is cladded with this clad sheet by rolling, followed by cold rolling to prepare a 0.5 mm-thick composite material.

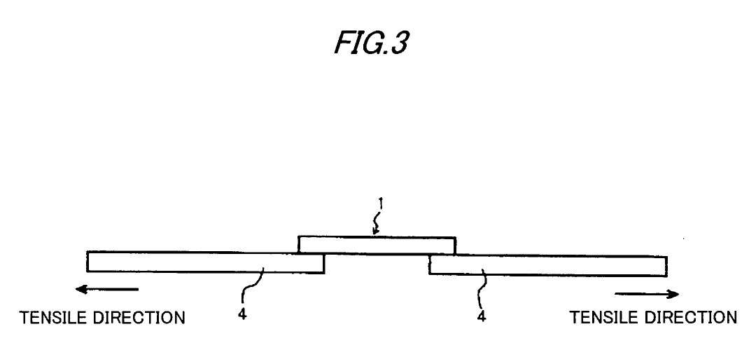

The brazing composite materials 1 prepared in the examples and comparative examples were taken off as plate pieces having a size of 10 mm×15 mm. Two stainless steel plates (SUS 304, each 15 mm×50 mm×3 mm) were provided as materials 4 to be brazed. As shown in FIG. 3, these two steel plates 4 were disposed while providing a space therebetween. The brazing composite material 1 was placed so that one end of the brazing composite material 1 comes into contact with one end of one of the material 4 to be brazed and the other end of the brazing composite material 1 comes into contact with one end of the other material 4 to be brazed. In this case, the brazing composite material 1 was placed so that the brazing layer 3 faced the material 4 to be brazed. In this state, the assembly was heat treated for brazing.

The area of contact between the composite material 1 and the two materials 4 (stainless steel plates) to be brazed was 15 mm×3 mm. The heat treatment for brazing was carried out in a vacuum atmosphere (2.0×10⁻³ Pa) under conditions of brazing temperature 1150° C. and brazing time 15 min.

The brazed products thus obtained were used as samples and subjected to a tensile test. As a result, all the samples were broken at a brazing material part (a brazing solidified part 5).

For the composite materials of the examples and comparative examples, the construction of the brazing layer 3 before brazing, the composition of the brazing solidified part 5 after brazing, and the tensile strength determined by the tensile test using the above samples are shown in Table 1.

TABLE 1

| | Content of individual | | | | Content of individual | | | | |
|---|---|---|---|---|---|---|---|---|---|
| | ingredients in | | | | ingredients in brazing | | | | |
| | brazing layer before | | | | solidified part after | | | | Tensile |
| | brazing, mass % | | | | brazing, mass % | | | | strength, |
| | Ni | Ti | Fe | W1/W2 | Ni | Ti | Fe | Cr | MPₐ |
| Ex. 1 | 56 | 34 | 10 | 0.62 | 29 | 18 | 44 | 9 | 192.3 |
| Ex. 2 | 50 | 30 | 20 | 0.63 | 37 | 19 | 37 | 7 | 177.9 |
| Comp. Ex. 1 | 36 | 59 | 5 | 0.38 | 16 | 71 | 8 | 5 | 51.3 |
| Comp. Ex. 2 | 34 | 56 | 10 | 0.38 | 18 | 68 | 11 | 3 | 37.9 |
| Comp. Ex. 3 | 38 | 62 | 0 | 0.38 | 24 | 70 | 5 | 1 | 59.6 |
| Comp. Ex. 4 | 30 | 70 | 0 | 0.30 | 17 | 69 | 10 | 4 | 46.0 |

Note)
W1: Weight of Ni ingredient contained in brazing layer before brazing.
W2: Total weight of Ni ingredient and Ti ingredient contained in the brazing layer.

For the comparative examples, in the tensile test, the brazing solidified part 5 is easily cracked, and, thus, the tensile strength is low, whereas, in the samples of the examples of the invention, the tensile strength is about three to six times higher than that of the samples of the comparative examples.

For the brazing layer 3 in the composite material 1, when the weight of Ni in the brazing layer 3 is W1 and the total weight of the Ni ingredient and Ti ingredient in the brazing layer 3 is W2, W1/W2 is 0.62 for Example 1 and 0.63 for Example 2. Both the values satisfy a requirement specified in claim 1, that is, W1/W2=0.58 to 0.68.

Further, for the content (% by mass) of Fe in the brazing layer 3 is 10% by mass for Example 1 and 20% by mass for Example 2. Both the values satisfy a requirement specified in claim 4, that is, 10 to 40% by mass. Furthermore, for both Examples 1 and 2, the composition of the brazing solidified part 5 satisfies a requirement specified in claim 6. Furthermore, it is apparent that Examples 1 and 2 satisfy requirements specified in the other claims, i.e., claims 2, 3, 5, 7, and 8.

Next, for samples prepared in the same manner as explained above, the brazing solidified part 5 was subjected to a simulated condensed water immersion test. The components of the solution used in the test were those following the testing liquid in method A specified in Japan Automobile Standards JASO M 611-92 “Internal Corrosion Test Method for Automotive Muffler.” The solution temperature was 80° C., and the immersion time was 1000 hr. The concentrations of the individual components in the testing liquid are shown in Table 2.

TABLE 2

| C1⁻ | SO₄²⁻ | SO₃²⁻ | NO₃⁻ | CH₃COO⁺ | |
|---|---|---|---|---|---|
| (ppm) | (ppm) | (ppm) | (ppm) | (ppm) | pH |
| 100 | 600 | 600 | 20 | 800 | 4.0 |

As a result of the test, it was found that, for all the examples and the comparative examples, the brazing solidified part 5 had better corrosion resistance than pure copper.

As described above, according to Examples 1 and 2, in a brazing composite material 1 comprising a base metal 2 bearing, on its surface, a brazing layer 3 having a three-layer structure of three different metallic layers, a composite material 1 (heat treatment material for brazing) having high bonding strength and corrosion resistance can be provided. Thus, Examples 1 and 2 are suitable for use, for example, in the production of members required to have strength and corrosion resistance, for example, heat exchangers (for example, coolers for exhaust gas recirculation devices, and coolers for fuel cell reformers) and fuel cells.

It should be noted that the invention is not limited to the above embodiments. For example, a construction may be adopted in which the brazing layer is provided both sides, rather than one side, of the base metal to constitute a brazing composite material. The stainless steel constituting the base metal may be any of austenitic, ferrite, and martensite stainless steels. Further, a plurality of brazing composite materials 1 may be brazed to each other with the aid of the brazing layer 3 in each of the composite materials to form a brazed product.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

1. A composite material for brazing, comprising a brazing layer provided on a surface of a base metal, the brazing layer satisfying a requirement represented by formula:
W1/W2=0.58 to 0.68
wherein W1 represents the weight of an Ni (nickel) ingredient contained in the brazing layer; and W2 represents the total weight of the Ni ingredient and a Ti (titanium) ingredient contained in the brazing layer.

2. The composite material for brazing according to claim 1, wherein the brazing layer comprises a Ni or Ni alloy layer, a Ti or Ti alloy layer, and an Fe (iron) or Fe alloy layer that are stacked in that order from the base metal side.

3. The composite material for brazing according to claim 1, wherein the brazing layer has an Fe content of 10 to 40% by mass.

4. The composite material for brazing according to claim 1, wherein the base metal is a stainless steel.

5. A brazed product comprising two materials brazed to each other with the aid of a brazing layer, the two materials being each the composite material for brazing according to claim 1, or one of the two materials being the composite material for brazing with the other material being other steel product, a brazing solidified part formed after the brazing comprising 20 to 50% by mass of Fe, 15 to 25% by mass of Ti, 25 to 45% by mass of Ni, and 1 to 15% by mass of Cr.

6. A brazed product comprising two materials brazed to each other with the aid of a brazing layer, the two materials being each the composite material for brazing according to claim 2, or one of the two materials being the composite material for brazing with the other material being other steel product, a brazing solidified part formed after the brazing comprising 20 to 50% by mass of Fe, 15 to 25% by mass of Ti, 25 to 45% by mass of Ni, and 1 to 15% by mass of Cr.

7. A brazed product comprising two materials brazed to each other with the aid of a brazing layer, the two materials being each the composite material for brazing according to claim 3, or one of the two materials being the composite material for brazing with the other material being other steel product, a brazing solidified part formed after the brazing comprising 20 to 50% by mass of Fe, 15 to 25% by mass of Ti, 25 to 45% by mass of Ni, and 1 to 15% by mass of Cr.

8. The brazed product according to claim 5, wherein the steel product is a corrosion resistant steel product.

9. The brazed product according to claim 5, wherein the brazing has been carried out in vacuum.
